(19) United States
(12) Patent Application Publication
(10) Pub. No.: US 2010/0060439 A1
(43) Pub. Date: Mar. 11, 2010

(54) Directional warning systems

(76) Inventor: Brian Robert Fitzgerald, Calmar (CA)

Correspondence Address: Brian Fitzgerald, Box 367, Calmar, AB, T0C 0V0, CA

(21) Appl. No.: 12/584,057

(22) Filed: Aug. 31, 2009

Related U.S. Application Data
(60) Provisional application No. 61/191,172, filed on Sep. 5, 2008.

(51) Int. Cl. B60Q 1/22; G08B 21/00

(52) U.S. Cl. 340/431; 340/463

(57) ABSTRACT

When vehicles are operating in reverse and backing up, there are significant dangers to pedestrians. Vehicles in which directional warning systems can be used on comprise large trucks and trailers, small vehicles, and construction and agricultural equipment and others. Directional warning systems is designed to warn pedestrians via audio and visual means. The apparatus is designed to be easily removably coupled to an existing trailer insert hookup and can be stored when not in use. Trailers can also be hooked in series while allowing the present invention to perform its intended function simultaneously. The invention serves to provide a cost-efficient system to provide increased safety, decreasing injuries and death to pedestrians from motorized vehicles.

### CROSS-REFERENCE TO RELATED APPLICATION

The present application is related to and claims priority from prior provisional application Ser. No. 61/191,172, filed Sep. 5, 2008 which application is incorporated herein by reference.

### BACKGROUND OF THE INVENTION

1. Field of the Invention

The present invention relates to providing a system for improved directional warning. More particularly this invention relates to providing a system for warning individuals when a vehicle is operating in a reverse direction.

2. Description of the Related Art

When vehicles are operating in reverse and backing up, there is significant danger to pedestrians. Vehicles in which Directional Warning Systems can be used on or with include large trucks and trailers, small vehicles, construction and agricultural equipment. Typically, construction and agricultural equipment may be refused access on a jobsite without some kind of warning when the vehicle is in reverse and backing up for safety and insurance liability reasons. These requirements may severely limit the mobility and earning potential of non-equipped commercial vehicles, when safety of this magnitude is a policy.

Normally, drivers have limited visibility as vehicles are operating in reverse. Visibility may be limited directly behind the vehicle as well as blind spots in the left and right side mirrors. These conditions create a hazard for individuals who may not be seen to be contacted by the vehicle. The hazard created may lead to severe bodily injury and even death should an individual be backed into. Children are particularly at risk because of their short stature. Workers concentrating on tasks may also be vulnerable due to inattention to other events and conditions occurring around them.

Further, vehicle backup lights may be covered by mud or dirt so that individuals may not be sufficiently warned of vehicle movements. This problem is compounded when vehicles are quiet due to muffled exhaust. Vehicles that have some form of an audible warning may also have their warning capacity diminished by loud vehicle noises such as that found on large trucks, construction and agricultural equipment.

Vehicles equipped from the factory with parts by the original equipment manufacturer, herein after “OEM” may be installed in places where mud, dirt, water, salt and other environmental elements may degrade the unit or make it unreliable in service. OEM audible beepers are typically expensive and must be ordered from the factory on initial purchase.

Individuals may decide to buy and install after market versions of beepers, however there is a danger that they will be installed incorrectly in a poor position and sound may be misdirected or the unit damaged during the installation. OEM and/or aftermarket installation units are not easily removable without additional work and tools being required.

Thus, a need exists for a cost-effective, efficient, reliable, removable and safe system to warn pedestrians of vehicles in a reverse condition to avoid the mentioned problems.

### BRIEF SUMMARY OF THE INVENTION

A directional warning apparatus for use with a motorized vehicle comprising: an enclosure; a sound producer emitting an audio warning signal to warn a pedestrian of reverse movement of a motorized vehicle; an electrical conductor; and wherein the directional warning apparatus comprises a male plug connector end and a plug receptacle end allowing a trailer to be plugged in series with the motorized vehicle while simultaneously using the directional warning apparatus. The directional warning apparatus is removably couplable. Additionally, it provides the directional warning apparatus further comprises an audio warning signal produced by a piezoelectric speaker. Also, it provides the directional warning apparatus with a visual warning signal wherein the pedestrian may receive an intermittent visual warning of a rearward motion of the motorized vehicle. In addition, the directional warning apparatus comprises a visual warning signal that comprises use of an intermittently flashed LED light to send the visual warning signal. The visual warning signal may also be a non-intermittently flashed LED light.

In accordance with the most preferred embodiment hereof, this invention provides a directional warning apparatus for use with the motorized vehicle comprising: an enclosure with a raised portion allowing the LED light to illuminate in a rearward direction for viewing by the pedestrian; a sound producer piezoelectric speaker capable of producing an audio warning signal to warn the pedestrian; sound vent(s); electrical conductor(s); blade(s); a printed circuit board; and a visual warning signal illuminator. The directional warning apparatus comprises a male plug connector end and a plug receptacle end allowing trailer(s) to be plugged in series with the motorized vehicle while simultaneously being able to use the directional warning apparatus.

In accordance with the most preferred embodiment hereof, this invention provides a kit comprising: the directional warning apparatus(es); and instruction manual(s). The instruction manual comprises a set of user instructions for maintenance and operation of the directional warning apparatus(es).

In accordance with the most preferred embodiment hereof, this invention provides a method of use herein by a user comprising: providing the directional warning apparatus wherein the user may insert the directional warning apparatus into the plug receptacle on the motorized vehicle; connecting the plug connector of the trailer into the plug receptacle end on the directional warning apparatus whereby the motorized vehicle may be electrically in communication with a plurality of trailers and simultaneously operate the directional warning apparatus. The directional warning apparatus can be used by itself and not have any other items plugged into it if so desired by the user. The present invention holds significant improvements and serves as a directional warning system. These and other features, aspects, and advantages of the present invention will become better understood with reference to the following drawings and description.

### BRIEF DESCRIPTION OF THE DRAWINGS

FIG. 1 shows a side view illustrating a directional warning system, as employed on a vehicle and trailer, according to the most preferred embodiment of the present invention.

FIG. 2 shows a perspective view, illustrating an apparatus of the directional warning system in operation, according to the most preferred embodiment of FIG. 1.

FIG. 3 shows a sectional view, illustrating the apparatus of the directional warning system, according to the most preferred embodiment of FIG. 1.

FIG. 4 shows a perspective view, illustrating a kit including the apparatus and an instruction manual for the directional warning system, according to the most preferred embodiment of FIG. 1.

The various embodiments of the present invention will hereinafter be described in conjunction with the appended drawings, wherein like designations denote like elements.

### DETAILED DESCRIPTION

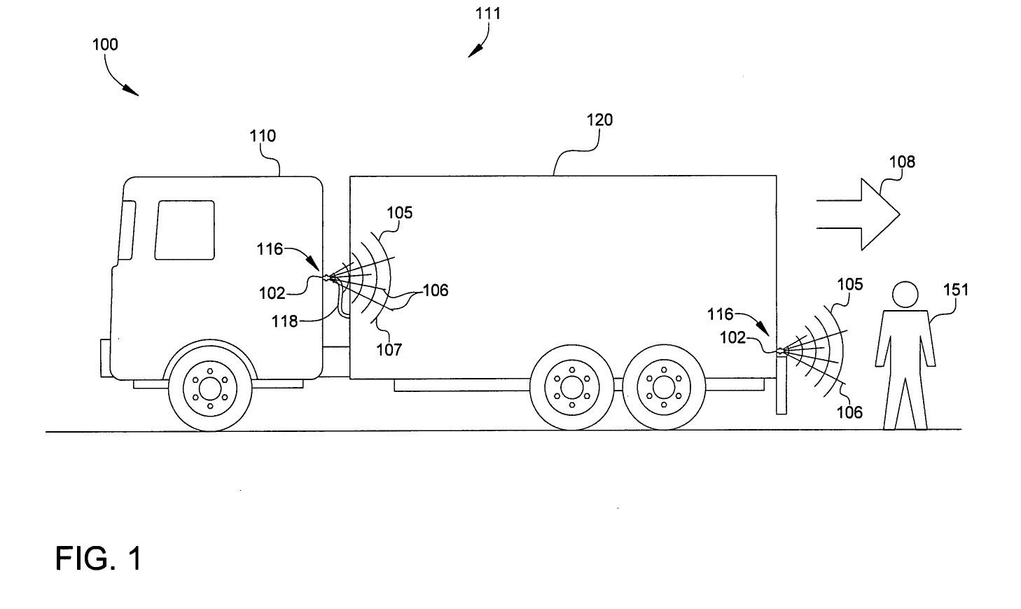

Referring now to FIG. 1 showing a side view illustrating directional warning system 100, as employed on motorized vehicle 110 and trailer 120, according to an embodiment of the present invention.

Directional warning system 100 is a system designed to provide at least one warning for at least one pedestrian 151, when motorized vehicle 110 and/or at least one trailer 120 is engaged in reverse and moving in a backwards direction indicated by directional arrow 108. Directional warning system 100 may provides at least one audio warning signal 105 and/or at least one visual warning signal 106 to a pedestrian(s) 151 standing behind or beside motorized vehicle 110 and/or trailer 120. Upon reading this specification, those with ordinary skill in the art will now appreciate that, under appropriate circumstances, considering such issues as design preference, user preferences, marketing preferences, cost, structural requirements, available materials, technological advances, etc., other warning arrangements such as, for example, different warning sounds, different duration of intermittency or non-intermittency, placement at different mounting positions on the vehicle such as on the front or sides, etc., may suffice.

Motorized vehicle 110 is preferably attached to trailer 120 preferably via at least one plug connector 118 that is connected into preferably at least one plug receptacle 116, as shown. The directional warning apparatus is removably couplable. Preferably at least one apparatus 102 is inserted in plug receptacle 116 of motorized vehicle 110 and into plug receptacle 116 trailer 120, as shown. Upon reading this specification, those with ordinary skill in the art will now appreciate that, under appropriate circumstances, considering such issues as design preference, user preferences, marketing preferences, cost, structural requirements, available materials, technological advances, etc., other connector arrangements such as, for example, screw together, magnetized coupling, wireless transmissions, apparatus can be used with or without adding a trailer and may include a plurality of trailers pulled in series or parallel, etc., may suffice.

Audio warning signal 105 is produced by apparatus 102 when vehicle 110 and is in reverse and backing up. Audio warning signal 105 makes a beeping notification that is preferably within the audible frequency of about 20 Hz and about 20,000 Hz that is transmitted via preferably at least one sound wave 107. Audio warning signal 105 preferably produces at least one intermittent beeping notification that will produce adequate sound volume in order to be heard in high noise environments such as construction sites, whereby, pedestrian 151 will be given ample warning notification and reaction time to avoid motorized vehicle 110 that is in being backed up. Upon reading this specification, those with ordinary skill in the art will now appreciate that, under appropriate circumstances, considering such issues as design preference, user preferences, marketing preferences, cost, structural requirements, available materials, technological advances, etc., other warning signal arrangements such as, for example, at different frequencies, may be a wave form that is felt or recognized by another sensory device, and may be used to indicate forward or sideways movements of different vehicles, etc., may suffice.

Furthermore, apparatus 102 additionally produces visual warning signal 106 when motorized vehicle 110 is in reverse and backing up. Directional warning system 100 preferably provides at least one adequate intermittent illumination, preferably using at least one white LED light 302 to preferably warn pedestrian 151 that motorized vehicle 110 is in reverse and backing up. The combination of audio warning signal 105 and visual warning signal 106 preferably serve in tandem to provide signals to activate two different sensory means whereby pedestrian 151 can recognize the impending danger. The combination of both signals is designed to serve redundantly so if pedestrian 151 should have poor hearing or eyesight the other warning will preferably suffice to catch their attention that a danger may be approaching. Many job-sites require that warning devices are used to protect workers from potential injuries and/or death. Upon reading this specification, those with ordinary skill in the art will now appreciate that, under appropriate circumstances, considering such issues as design preference, user preferences, marketing preferences, cost, structural requirements, available materials, technological advances, etc., other visual warning signal arrangements such as, for example, different colors of light, different wavelengths, different lengths of intermittency or non-intermittency, may be a light wave form that is felt or recognized by another sensory device, and may be used to indicate forward or sideways movements of different vehicles, may or may not recognize obstacles behind the vehicle based on shape or heat trace, etc., may suffice.

Apparatus 102 may be preferably readily connected and/or disconnected preferably by at least one user 150 for at least one non-use period(s) and for storage. FIG. 1 shows directional warning system 100 as preferably used with at least one commercial truck and trailer setup 111, providing a plurality of audio warning signal(s) 105 and visual warning signal(s) 106. Upon reading this specification, those with ordinary skill in the art will now appreciate that, under appropriate circumstances, considering such issues as design preference, user preferences, marketing preferences, cost, structural requirements, available materials, technological advances, etc., other connection arrangements such as, for example, apparatus may be permanently mounted, permanently wired, etc., may suffice.

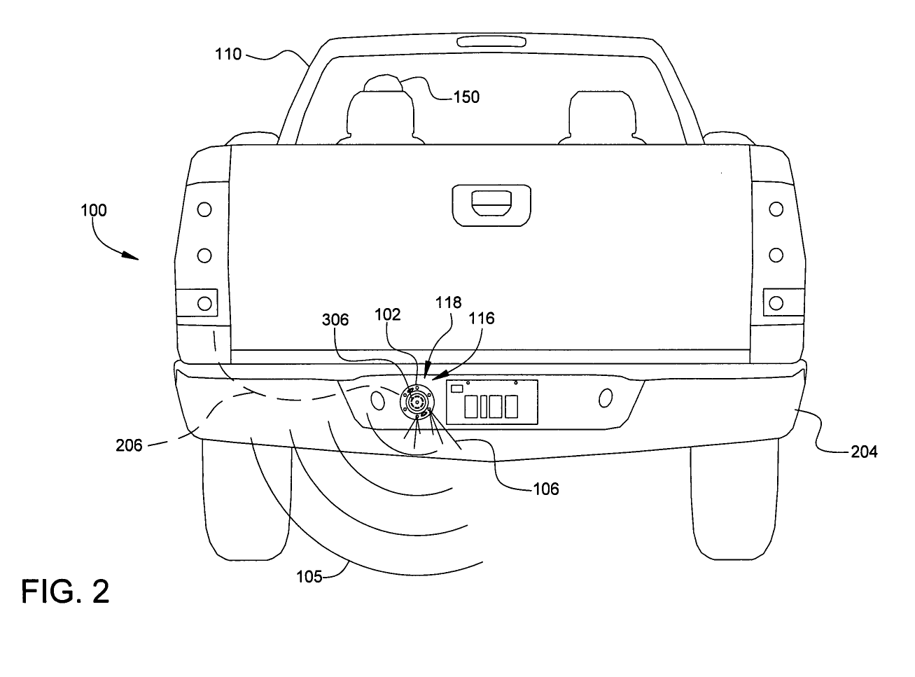

FIG. 2 shows a perspective view, illustrating apparatus 102 of directional warning system 100 in operation, according to the most preferred embodiment of FIG. 1.

Apparatus 102 is shown as inserted into at least one plug receptacle 116 of a passenger version of motorized vehicle 110. Plug receptacle 116 may preferably be located at the rear of motorized vehicle 110 preferably in, or alternately preferably attached to rear bumper 204, as shown. Apparatus 102 is preferably wired to match mating plug receptacle 116. Plug receptacle 116 preferably provides at least one connection for apparatus 102, preferably permitting at least one power source from motorized vehicle 110 to be transmitted to operate visual warning signal 106 and audio warning signal 105. When user 150 shifts into at least one reverse gear in motorized vehicle 110, preferably at least one signal is sent via at least one electrical harness 206 to plug receptacle 116 then to at least one blade 306 in plug connector 118. Upon reading this specification, those with ordinary skill in the art will now appreciate that, under appropriate circumstances, considering such issues as design preference, user preferences, marketing preferences, cost, structural requirements, available materials, technological advances, etc., other placement arrangements such as, for example, mounting on the front or sides of the vehicle, mounting on various types of vehicles, having its own power source rather than relying on power from the vehicle, and use of more than one harness or no harness, etc., may suffice.

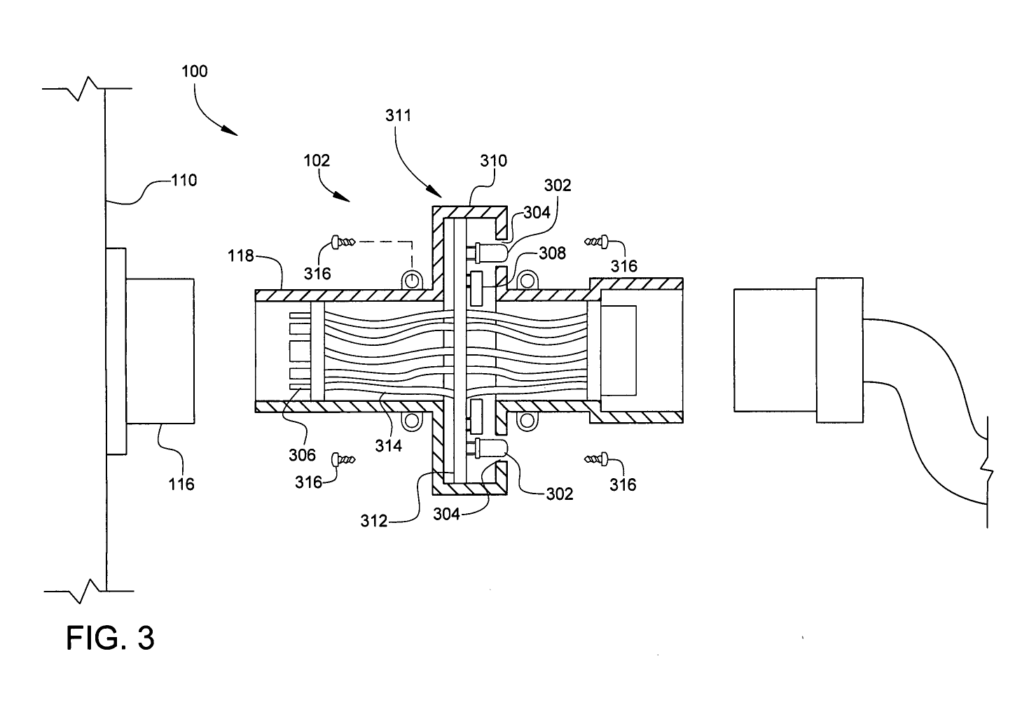

FIG. 3 shows a sectional view, illustrating apparatus 102 of directional warning system 100, according to the most preferred embodiment of FIG. 1.

Apparatus 102 preferably comprises the following components: preferably at least one enclosure 310; preferably at least one blade 306; preferably at least one wire 314; preferably at least one printed circuit board 312; preferably at least one LED light 302; preferably at least one sound vent 304; and preferably at least one piezoelectric speaker 308. Enclosure preferably encloses the components aforementioned and preferably comprises plastic or alternately preferably comprises at least one metal or metal alloy. Enclosure 310 must be tough, durable and cost-effective to manufacture. Enclosure 310 may comprise an outer shell and necessary internal parts of a trailer plug. Manufacturing of enclosure preferably comprises using at least one molding, or alternately preferable at least one stamping process. Enclosure is preferably manufactured in a two-piece construction wherein both sides are connected together using at least one fastener, preferably at least one screw 316, more preferably four screws 316. Ideally enclosure 310 is preferably essentially water-tight. Enclosure 310 preferably comprises at least one larger diameter portion 311 to preferably allow greater visibility of LED light 302 preferably in a rearward direction. Upon reading this specification, those with ordinary skill in the art will now appreciate that, under appropriate circumstances, considering such issues as design preference, user preferences, marketing preferences, cost, structural requirements, available materials, technological advances, etc., other enclosure arrangements such as, for example, use of different materials including ferrous and non-ferrous metals and/or their alloys, different manufacture methods, single-piece constructions, uses of different kinds and numbers of fasteners, etc., may suffice.

Printed circuit board 312 is used to mechanically support and electrically connect electronic components using conductive pathways, or traces, etched from copper sheets laminated onto a non-conductive substrate. Printed circuit board 312 comprises durable, inexpensive construction and materials, and can be highly reliable. Printed circuit board 312 requires more layout effort and higher initial cost than either wire-wrapped or point-to-point constructed circuits, but are much cheaper and faster for high-volume production as required in the most preferred embodiment of the present invention to maintain cost-effectiveness in production. Printed circuit board 312 is populated by at least one resistor, at least one soldered connection, at least one capacitor and appropriate wires 314. Those with ordinary skill in the art will now appreciate that upon reading this specification and by their understanding the art of printed circuit boards as described herein, methods of manufacture, wiring, population and installation will be understood by those knowledgeable in such art.

LED light 302 is a light-emitting semiconductor diode that emits light when an electrical current is applied in the forward direction of the device, as in the simple LED circuit. There are two ways of producing the preferred high intensity white-light using LED lights 302 as may used in the most preferred embodiment of the present invention. The first method is to use individual LED lights 302 that emit three primary colors, specifically red, green, and blue, and then mix all the colors to produce white LED light 302. The preferred method is to use a phosphor material to convert monochromatic light from a blue or UV LED to broad-spectrum white light. In the preferred method a fraction of the blue light undergoes the Stokes shift being transformed from shorter wavelengths to longer. Although the preferred method is slightly lower in efficiency because of heat loss and phosphor degradation it is much simpler and cost-effective to manufacture in large quantities. Those with ordinary skill in the art will now appreciate that upon reading this specification and by their understanding the art of LED lights as described herein, other methods of manufacture, wiring, use of other colors or combinations will be understood by those knowledgeable in such art.

Sound vent 304 preferably permits at least one sound wave as preferably created by piezoelectric speaker 308 to preferably efficiently exit enclosure 310 to sound “beeped warning” to pedestrian 151. Piezoelectric speaker 308 is preferably used within the most preferred embodiment of the present invention because it is substantially resistant to overloads which would normally destroy most high frequency drivers over an extended time period, and piezoelectric speakers 308 may be used without a crossover because of its inherent electrical properties. Upon reading this specification, those with ordinary skill in the art will now appreciate that, under appropriate circumstances, considering such issues as design preference, user preferences, marketing preferences, cost, structural requirements, available materials, technological advances, etc., other venting and speaker arrangements such as, for example, holes, no vents, openings for use with other speaker or sound producing means, etc., may suffice.

Blade 306 and wire 314 create a path by which electricity is provided at least one specified path to preferably allow at least one electrical communication between plug connector 118 and plug receptacle 116 on motorized vehicle 110. The most preferred embodiment of the present invention preferably allows motorized vehicle 110 to be coupled electrically through apparatus 102 to at least one plurality of trailers 120 in series if desired by user 150.

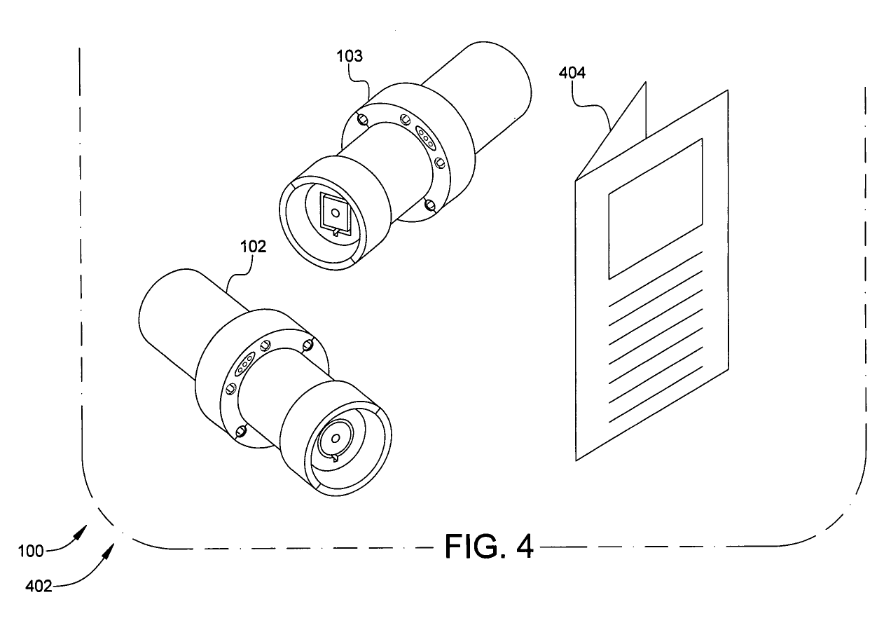

FIG. 4 shows a perspective view, illustrating kit 402 including apparatus 102 and instruction manual 404 for directional warning system 100, according to the most preferred embodiment of FIG. 1.

Kit 402 preferably comprises at least one apparatus 102 of the most preferred embodiment and/or alternately at least one alternately preferred apparatus 103. Kit 402 further preferably comprises at least one instruction manual 404 that includes any necessary installation, maintenance and warranty information for user(s) 150 to properly operate and maintain apparatus 102 of directional warning system 100. Upon reading this specification, those with ordinary skill in the art will now appreciate that, under appropriate circumstances, considering such issues as design preference, user preferences, marketing preferences, cost, structural requirements, available materials, technological advances, etc., other kit contents such as, for example, replacement LED light bulb(s), replacement piezoelectric speaker(s), replacement wiring, replacement blades, replacement housings, instruction manuals including other elements and sections such as trouble-shooting, safety instructions, volume control and adjustment, light strobe adjustment or intermittency duration, etc., may suffice.

A method of use for a directional warning apparatus comprising: a) providing at least one directional warning apparatus wherein such at least one user may removably couple said directional warning apparatus into at least one plug receptacle on a motorized vehicle; and b) connecting the at least one plug connector of at least one trailer into at least one plug receptacle end on such at least one directional warning apparatus whereby such at least one motorized vehicle may be electrically in communication with such at least one plurality of trailers and operate such at least one directional warning apparatus simultaneously.

Although applicant has described applicant's preferred embodiments of this invention, it will be understood that the broadest scope of this invention includes modifications such as diverse shapes, sizes, and materials. Such scope is limited only by the below claims as read in connection with the above specification. Further, many other advantages of applicant's invention will be apparent to those skilled in the art from the above descriptions and the below claims.

The embodiments of the invention described herein are exemplary and numerous modifications, variations and rearrangements can be readily envisioned to achieve substantially equivalent results, all of which are intended to be embraced within the spirit and scope of the invention.

1) A directional warning apparatus for use with at least one motorized vehicle comprising:
a) at least one enclosure;
b) at least one sound producer producing at least one audio warning signal to warn a pedestrian of rearward movement of said motorized vehicle; and
c) at least one electrical conductor;
d) wherein said directional warning apparatus comprises at least one male plug
connector end and at least one plug receptacle end allowing at least one trailer to be plugged in series with said motorized vehicle while simultaneously using said directional warning apparatus.

2) The directional warning apparatus of claim 1 wherein said directional warning apparatus is removably couplable to a plug receptacle of said motorized vehicle.

3) The directional warning apparatus of claim 1 further comprising at least one audio warning signal wherein said at least one audio warning signal is produced by at least one piezoelectric speaker.

4) The directional warning apparatus of claim 3 wherein said audible frequency comprises an audible tone within a range between about 20 Hz and about 20,000 Hz.

5) The directional warning apparatus of claim 1 further comprising at least one visual warning signal wherein said pedestrian may receive at least one intermittent visual warning of a rearward motion of said motorized vehicle.

6) The directional warning apparatus of claim 5 further comprising at least one visual warning signal wherein said at least one visual warning signal comprises use of at least one intermittently flashed LED light to send said at least one visual warning signal.

7) The directional warning apparatus of claim 5 further comprising at least one visual warning signal wherein said at least one visual warning signal comprises use of at least one non-intermittently flashed LED light to send such at least one visual warning signal.

8) The directional warning apparatus of claim 1 comprising:
a) at least one enclosure with at least one raised portion allowing at least one LED light to illuminate in a rearward direction for viewing by a pedestrian;
b) at least one sound producer piezoelectric speaker capable of producing at least one audible audio warning signal to warn said pedestrian;
c) at least one sound vent;
d) at least one electrical conductor;
e) at least one blade;
f) at least one printed circuit board;
g) at least one visual warning signal illuminator; and
h) wherein said directional warning apparatus comprises at least one male plug connector end and at least one plug receptacle end allowing at least one trailer to be plugged in series with such at least one motorized vehicle while simultaneously using said directional warning apparatus.

9) A kit for a directional warning apparatus comprising:
a) at least one removably couplable directional warning apparatus; and
b) at least one instruction manual wherein such at least one instruction manual comprises at least one set of user instructions for at least one maintenance and at least one operation of said at least one directional warning apparatus.

10) A method of use for a directional warning apparatus comprising:
a) providing at least one directional warning apparatus wherein such at least one user may removably couple said directional warning apparatus into at least one plug receptacle on a motorized vehicle; and
b) connecting the at least one plug connector of at least one trailer into at least one plug receptacle end on such at least one directional warning apparatus whereby such at least one motorized vehicle may be electrically in communication with such at least one plurality of trailers and operate such at least one directional warning apparatus simultaneously.
